(19) United States
(12) Patent Application Publication
(10) Pub. No.: US 2020/0363903 A1
(43) Pub. Date: Nov. 19, 2020

(54) ENGAGEMENT ANALYTIC SYSTEM AND DISPLAY SYSTEM RESPONSIVE TO INTERACTION AND/OR POSITION OF USERS

(71) Applicant: T1V, Inc., Charlotte, NC (US)

(72) Inventors: Ronald A. LEVAC, Mount Airy, NC (US); Michael R. FELDMAN, Huntersville, NC (US)

(73) Assignee: T1V, Inc., Charlotte, NC (US)

(21) Appl. No.: 16/986,292

(22) Filed: Aug. 6, 2020

Related U.S. Application Data
(63) Continuation of application No. 15/900,269, filed on Feb. 20, 2018.
Application No. 15/900,269 is a continuation of application No. PCT/US2016/047886, filed on Aug. 19, 2016.
(60) Provisional application No. 62/208,082, filed on Aug. 21, 2015.
(60) Provisional application No. 62/244,015, filed on Oct. 20, 2015.

(51) Int. Cl. G06F 3/042; G09F 9/302; G09F 27/00; G06Q 30/02; G06T 7/70; G06K 9/00

(52) U.S. Cl. CPC G06F 3/0425; G09F 9/3026; G09F 27/005; G06T 2207/30242; G06Q 30/0261; G06T 7/70; G06K 9/00228; G06Q 30/02

(57) ABSTRACT

A system includes a display in a setting, the display being mounted vertically on a wall in the setting, a camera structure mounted on the wall on which the display is mounted, and a processor. The processor may count a number of people passing the digital display and within the view of the display even when people are not looking at the display. The processor may process an image form the camera structure to detect faces to determine the number of people within the field of view (FOV) of the display at any given time. The processor may dynamically change a resolution on the display based on information supplied by the camera.

### CROSS-REFERENCE TO RELATED APPLICATIONS

This application is a continuation of U.S. application Ser. No. 15/900,269, filed Feb. 20, 2018, which is a continuation of International Application No. PCT/US2016/047886, filed Aug. 19, 2016, which claims priority under 35 U.S.C. § 119(e) to U.S. Provisional Application No. 62/208,082, filed on Aug. 21, 2015, and U.S. Provisional Application No. 62/244,015, filed on Oct. 20, 2015, each of which are incorporated herein by reference in their entirety.

### SUMMARY OF THE INVENTION

One or more embodiments is directed to a system including a camera and a display that is used to estimate the number of people walking past a display and/or the number of people within the field of view (FOV) of the camera or the display at a given time, that can be achieved with a low cost camera and integrated into the frame of the display.

A system may include a digital display, a camera structure, a processor, and a housing in which the display, the camera, and the processor are mounted as a single integrated structure, wherein the processor is to count a number of people passing the digital display and within the view of the display even when people are not looking at the display.

The camera structure may include a single virtual beam and the processor may detect disruption in the single virtual beam to determine presence of a person in the setting.

The camera structure may include at least two virtual beams and the processor may detect disruption in the at least two virtual beams to determine presence and direction of movement of a person in the setting.

The camera structure may be a single camera.

The camera structure may include at least two cameras mounted at different locations on the display.

A first camera may be in an upper center of the display and a second camera may be a lateral camera on a side of the display. The processor may perform facial recognition from an output of the first camera and determine the number of people from an output of the second camera.

A third camera may be on a side of the display opposite the second camera. The processor may determine the number of people from outputs of the second and third cameras.

When the processor detects a person, the processor may then determine whether the person is glancing at the display.

When the processor has determined that the person is glancing at the display, the processor may determine whether the person is looking at the display for a predetermined period of time.

The predetermined period of time may be sufficient for the processor to perform facial recognition on the person.

When the processor determines the person is close enough to interact with the display and detect that the display is interacted with, the processor may map that person to the interaction and subsequent related interactions.

The processor may determine the number of people within the FOV of the display at any given time.

The processor may perform facial detection to determine a total number of people viewing the display at a given time interval, and then generate a report that includes the total number of people walking by the display as well as the total number of people that viewed the display within the given time interval.

One or more embodiments is directed to increasing the amount of interactions between people and a display, by dividing the interaction activity in to stages and capturing data on the number of people in each stage and then dynamically changing the content on the display with the purpose of increasing the percentage of conversions of each person in each stage to the subsequent stage.

A system may include a digital display, a camera structure, a processor; and a housing in which the display, the camera, and the processor are mounted as a single integrated structure, wherein processor is to process an image form the camera structure to detect faces to determine the number of people within the field of view (FOV) of the display at any given time, is to process regions of the camera structure to determine the number of people entering and exiting the FOV at any given time, even when a person is not looking at the camera, and is to determine a total number of people looking at the display during any particular time interval.

The processor may change content displayed on the digital display in accordance with a distance of a person from the digital display.

The processor may categorize different levels of a person's interaction with the digital display into stages including at least the of the following stages: walking within range of a display; glancing in the direction of a display; walking within a certain distance of the display; looking at the display for a certain period of time; and touching or interacting with the display with a gesture.

The processor may change the content on the display in response to a person entering each of the at least three stages.

The processor may track a number of people in each stage at any given time, track a percentage of people that progress from one stage to another, and update an image being displayed accordingly.

One or more embodiments is directed to a system including a camera and a display that is used to estimate the number of people in a setting and perform facial recognition.

An engagement analytic system may include a display in a setting, the display being mounted vertically on a wall in the setting, a camera structure mounted on the wall on which the display is mounted, and a processor to determine a number of people in the setting and to perform facial recognition on at least one person in the setting from an output of the camera structure.

The system may include a housing in which the display, the camera, and the processor are mounted as a single integrated structure.

One or more embodiments is directed to a system including a camera and a display that is used to dynamically change a resolution of the display in accordance with information output by the camera, e.g., a distance a person is from the display.

A system may include a display in a setting, the display being mounted vertically on a wall in the setting, a camera structure mounted on the wall on which the display is mounted, and a processor to dynamically change a resolution on the display based on information supplied by the camera.

The processor may divide distances from the display into at least two ranges and to change the resolution in accordance with a person's location in a range.

The range is determined may be accordance with a person in range closest to the display.

When a person is in a first range closest to the display, the processor may control the display to display a high resolution image.

When people are only in a second range furthest from the display, the processor may control the display to display a low resolution image.

When people are in a third range between the first and second ranges, and no one is in the first range, the processor may control the display to display a medium resolution image.

When no one is within any range, the processor is to control the display to display a low resolution image or no image.

### BRIEF DESCRIPTION OF THE DRAWINGS

Features will become apparent to those of skill in the art by describing in detail exemplary embodiments with reference to the attached drawings in which:

FIG. 1 illustrates a schematic side view of a system according to an embodiment in a setting;

FIG. 2 illustrates a schematic plan view of a display according to an embodiment;

FIG. 3 illustrates a schematic plan view of a display according to an embodiment;

FIG. 4 illustrates an example of a configuration of virtual laser beam regions within a field of view in accordance with an embodiment;

FIGS. 5 to 9 illustrate stages in analysis of people within the setting by the display according to an embodiment;

FIG. 10 illustrates a flowchart of a method for detecting a number of people within a field of view of a camera in accordance with an embodiment;

FIG. 11 illustrates a flowchart of a method for analyzing a level of engagement according to an embodiment;

FIG. 12 illustrates a portion of flowchart of a method for determining whether to change content based on a distance of a person to the display;

FIG. 13 illustrates a portion of flowchart of a method for changing content based on a stage;

FIG. 14 illustrates different views as a person approaches the display; and

FIGS. 15 to 17 illustrate stages in analysis of people within the setting by the display according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

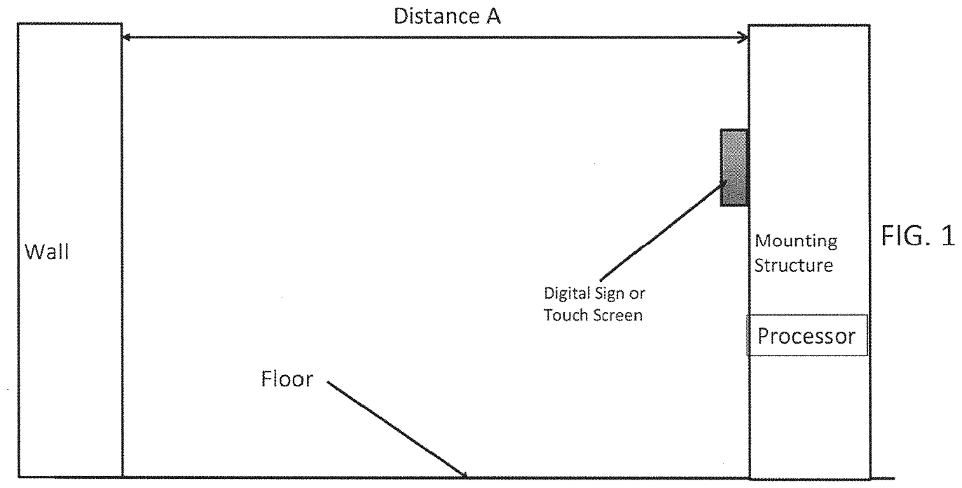

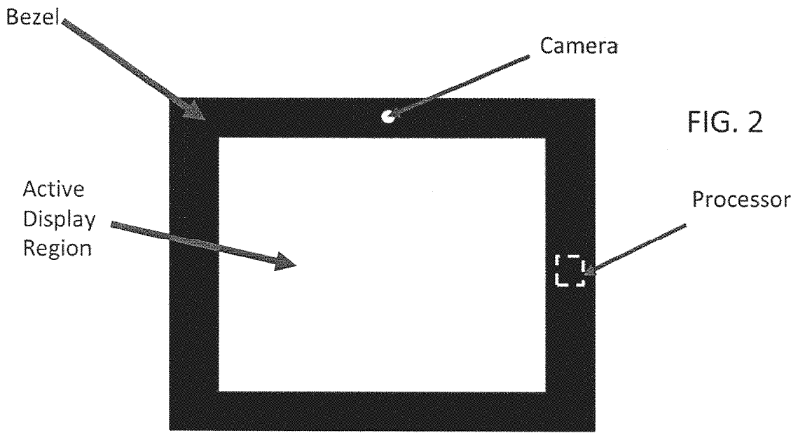

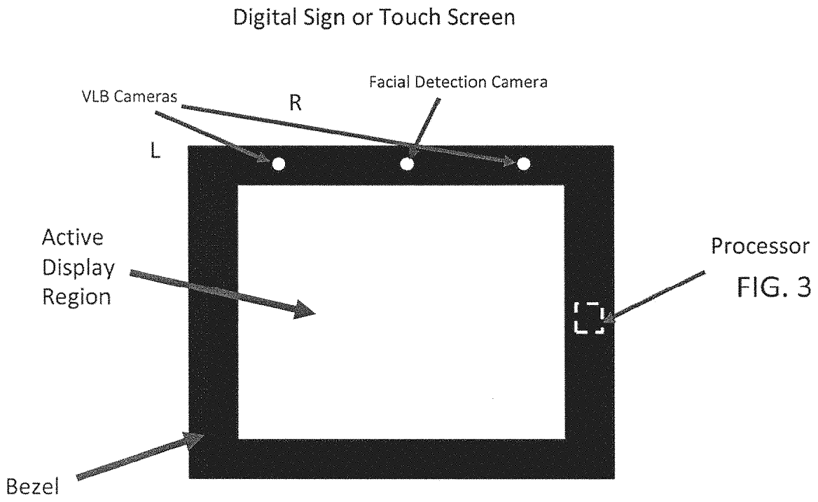

FIG. 1 illustrates a schematic side view of a system according to an embodiment and FIGS. 2 and 3 are plan views of a Digital Display according to embodiments. As shown in FIG. 1, the system includes the Digital Display, e.g., a digital sign or an interactive display, such as a touchscreen display, that displays an image, e.g., a dynamic image. The system also includes a camera (see FIGS. 2 and 3) which may be mounted near the Digital Display or within a frame or the bezel surrounding the Digital Display (see FIGS. 2 and 3). In a setting, the Digital Display may be mounted on a mounting structure, e.g., on a wall, to face the setting. The setting may include an obstruction or static background image, e.g., a wall, a predetermined distance A from the mounting structure. The Background Image is the image captured by the camera when no people are present within the field of view of the camera. If the Background Image is not static, particularly with respect to ambient lighting, e.g., outside, the Background Image may be updated to change with time. The camera and the display are in communication with a processor, e.g., a processor hidden within the mounting structure (FIG. 1) or within the frame or bezel of the Digital Display (see FIG. 2).

An example of a Digital Display to be used in FIG. 1 is illustrated in FIG. 2. As shown therein, the Digital Display may include a bezel surrounding the display area and the bezel may have a camera mounted therein, e.g., unobtrusively mounted therein. The camera may be used for face recognition and for determining a level of engagement of people in the setting, as will be discussed in detail below.

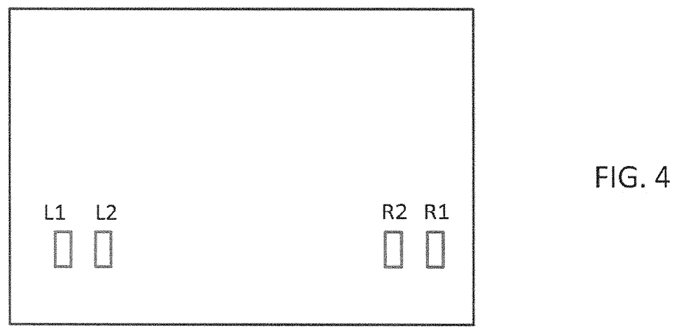

Another example of a display to be used in FIG. 1 is illustrated in FIG. 3. As shown therein, the Digital Display may be surrounded by a bezel that includes three cameras mounted therein. A central camera may be used for face recognition and lateral cameras may be used for determining a level of engagement of people in the setting, as will be discussed in detail below. Each lateral camera may be directed downward towards the floor, but still be mounted with the frame. For example, a left side camera L would have a field of view directed downward and toward the left and a right side camera R would have a field of view directed downward and toward the right. The image captured by each of these cameras (or the single camera of FIG. 2) may be divided in to multiple sections (see FIG. 4). Each camera would then look for changes in the pixels within each of these sections to determine if a person is walking past and which way they are walking. This would then allow for the calculation of the number of people within the field of view at any given time, as well as to calculate the number of people entering the field of view over a given time interval and including information on the amount of time people spend within the field of view. These sections will be referred to as virtual laser beam (VLB) regions of the camera image. The processor in FIG. 3 will look within the VLB areas of the images obtained from the cameras. While the VLB cameras are shown in FIG. 3 as being in the bezel of the Digital Display, the VLB cameras may be mounted on a same wall as the Digital Display, but not integral therewith.

In one approach, there may be one VLB region within the center of the FOV of a single camera. Every time the average brightness of all of the pixels within the VLB region changes by a given amount, the VLB is considered broken and a person has walked by the Digital Display. In this manner the number of people over a given period of time that have walked by the display can be estimated by simply counting the number of times the VLB is broken. The problem with this simple approach is that if a person moves back and forth near the center of the FOV of the display, each of these movements may be counted as additional people. Further, this embodiment would not allow for counting the number of people within the FOV of the display at any given time.

An embodiment having more than one VLB region is shown in FIG. 4. When there are two VLB areas each placed near each other, then the timing of the breaks may be used to determine which direction the person is walking and the speed of walking. In FIG. 4, there are two VLB areas on the left side (areas L1 and L2) and two VLB areas on the right side (areas R1 and R2). If at least two pairs of VLB areas are used as shown in this figure then the processor can also determine the number of people within the field of view at any given time, the number of people approaching from each side, how long they stay within range, the number of people exiting from each side, and so forth. The pattern of VLB areas and counting algorithms can be modified based on low versus high traffic, slow versus fast traffic, individuals versus pack movement.

The entire rectangle in FIG. 4 may be a representation of the entire FOV of the central camera for example in FIG. 2, i.e., the area of the entire image captured by a single screen shot of the camera. The VLB areas marked correspond to those particular pixels of the image. Alternatively, the areas L1 and L2 could be regions on the camera pointing toward the left in FIG. 3 and the areas R1 and R2 could be captured from the camera in FIG. 3 pointing to the right.

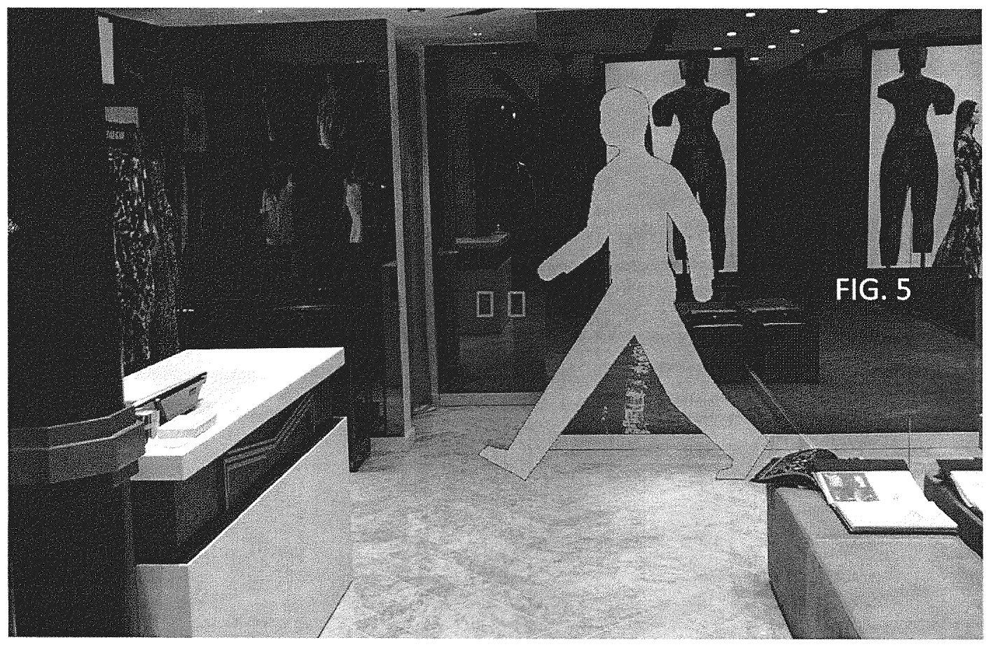

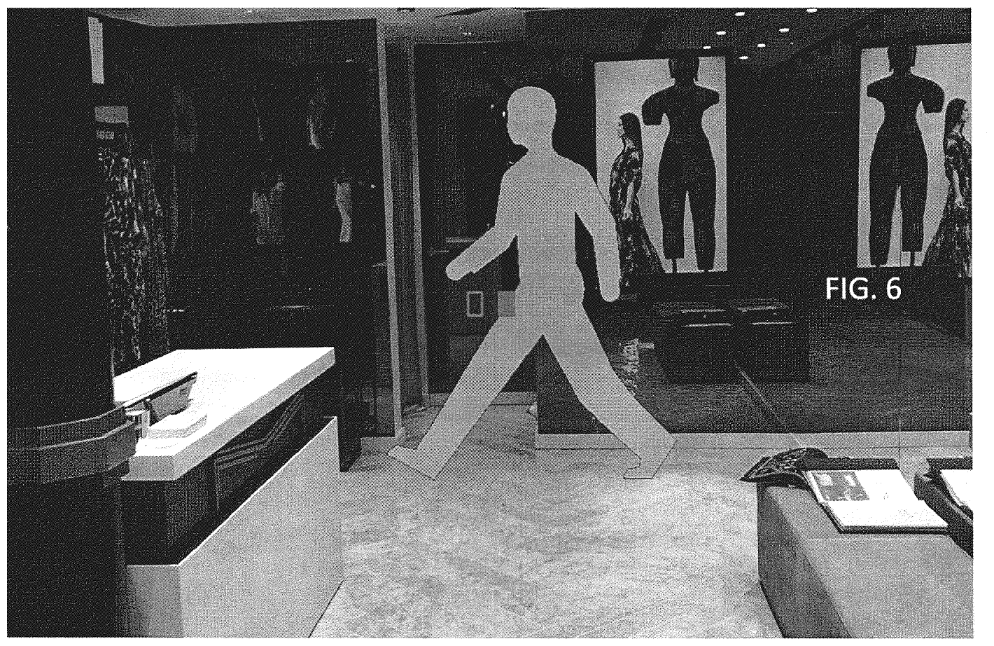

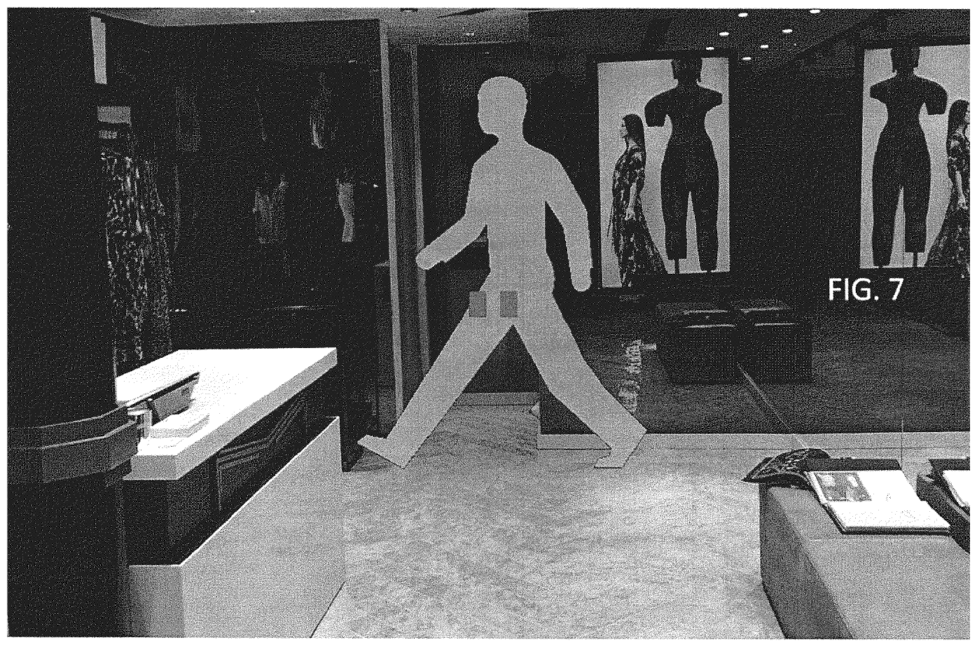

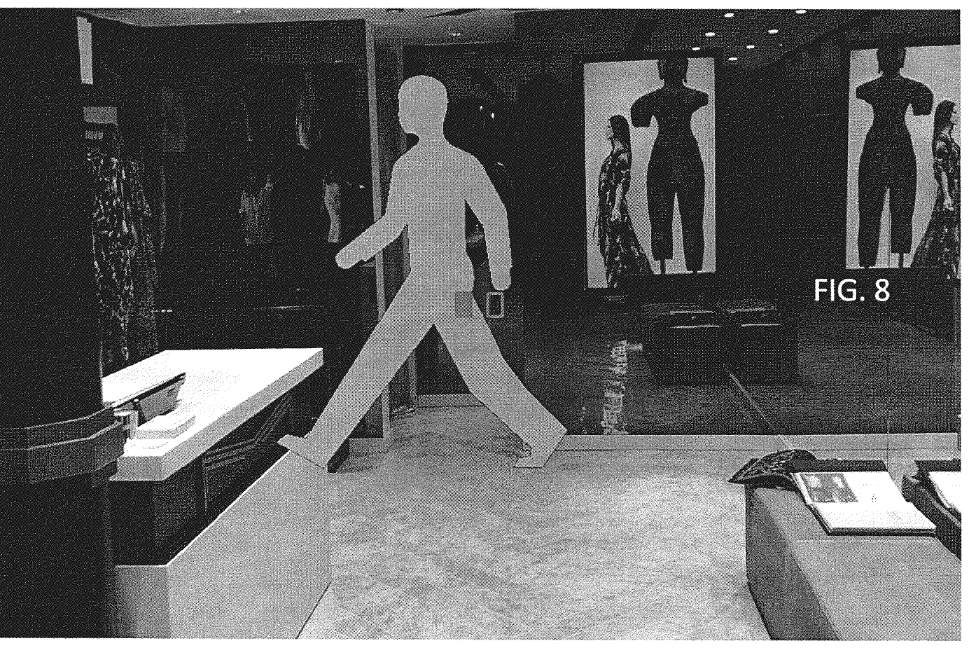

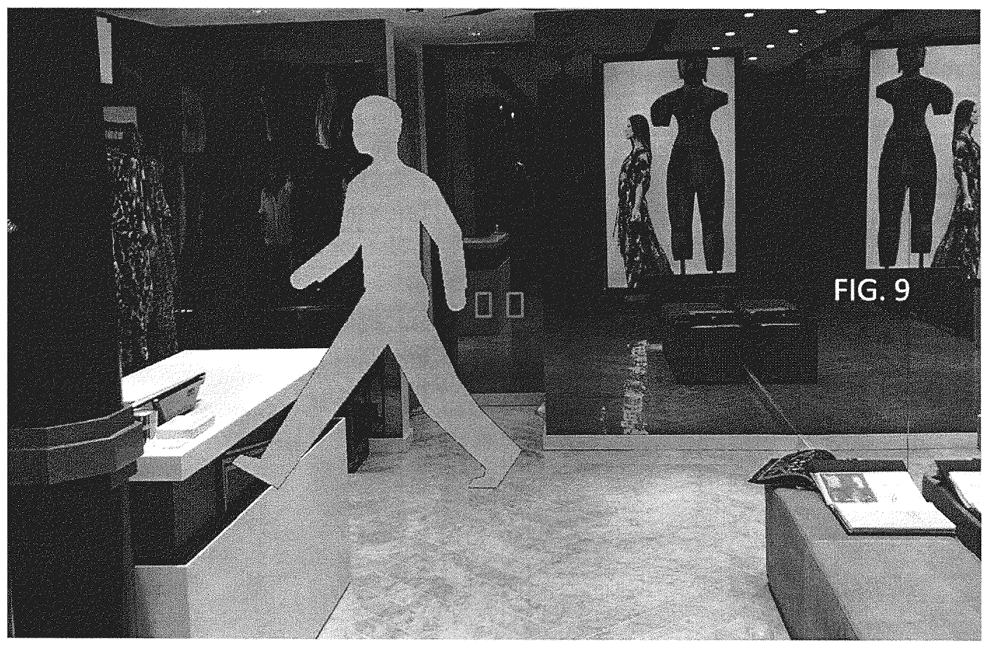

FIGS. 5 to 9 illustrate stages in analysis of people within the setting by the display according to an embodiment. Within the FOV of the camera of FIG. 2 or the lateral cameras in FIG. 3 particular regions are first designated to serve as VLB regions, e.g., two adjacent but non-abutting regions outlined in red in FIG. 5, e.g. the VLB regions L1, L2 in FIG. 9. Alternatively, these VLB regions may be abutting regions.) Initially, the VLB regions are set and the Initial Data from the Background Image is stored for each VLB sensor region. The Initial Data includes the color and brightness of the pixels within each VLB region when no people are present. When a person walks within the setting, the person first changes the image at a one of the regions, i.e., breaks a first VLB, as shown in FIG. 6, then the person changes the image at another region, i.e., breaks a second VLB, such that both VLBs are broken, as shown in FIG. 7. As the person continues to move in the same direction, the first VLB region will return to Initial Data, as shown in FIG. 8, and then the second VLB will return to its Initial Data, as shown in FIG. 9. The processor will detect this sequence and can determine the presence of a person and a direction in which the person is moving.

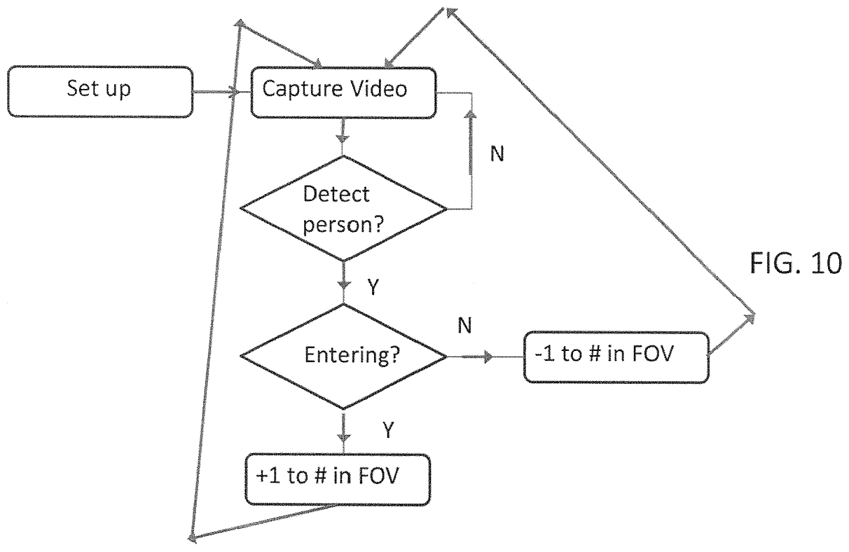

FIG. 10 illustrates a flowchart of a method for detecting a number of people within a field of view of a camera. First, during set-up, the VLB regions of the camera(s), e.g., two on a left side and two on a right side, are stored in memory, e.g. of the processor or in the cloud, and a Background Image of the setting is captured, e.g., brightness, color, and so forth, when the setting has no people present to provide and store the Initial Data for each VLB region.

Then, the video from the camera(s) is captured, e.g., stored. The processor then analyzes the video to determine whether a person has entered or exited the field of view. In particular, data on VLB regions L1, L2, R1, R2 (shown in FIG. 4) for multiple screen shots from the video for multiple seconds. If the data on VLB regions L1, L2, R1, R2 is unchanged or not significantly changed over this time period, then it is determined that no one has entered or exited the FOV and the processor will keep monitoring the captured video from the camera, until the Detect Person Criteria, defined below, is found.

If the data does change on the camera(s) from the Initial Data captured in the set up, then types of changes would be further examined to determine if a person has entered or exited the FOV. For example, considering one pair of VLB regions, the criteria could be a change to a specific new data values on a first one of the pair of VLB regions followed within a certain time period the same or similar change on both VLB regions in the pair followed by the same change only on the second VLB region of the pair, i.e., Detect Person Criteria. If, for example, the brightness of VLB region L1 and L2 in FIG. 4 were both to become brighter at the same time and stay brighter for a period of time, then an event other than a person entering or exiting the FOV, could be assumed, e.g., a light was turned on. In this case the Detect Person Criteria would not have been met.

If the Detect Person Criteria is detected on either of the VLB region pairs in FIG. 4 or any other VLB region pairs within a single camera or from multiple cameras, then it is determined that a person has entered or exited the FOV.

Once data has changed on a VLB region (for example becomes darker, brighter or changes color), then the nature of the change may be analyzed to determine what type of change has occurred. For example, consider a single VLB pair on the left side of the FOV of a single camera or the left side of the combined FOV of multiple cameras (e.g. VLB regions L1 and L2 in FIG. 4). Suppose the data on the left VLB region within this VLB pair (L1) becomes darker and more red, followed by the data on the right VLB region within this VLB pair (L2) becoming darker and more red one or two seconds later. Then, it may be determined that a person has entered the FOV and one may be added to the number of people in the FOV. On the other hand, if the new data appears on the right VLB region within this left side VLB pair (L2) with the left VLB region (L1) becoming darker and more red one or two seconds later, then, it may be determined that a person has exited the FOV and one may be subtracted from the number of people in the FOV. The opposite sequence on the VLB regions on the right side would hold as well (VLB regions R1 and R2).

This determination may be varied in accordance with a degree of traffic of the setting.

Example of a Low Traffic Algorithm

The Detect Person Criteria may be a change in the data captured on any VLB sensor. Suppose a change from the Initial Data is detected on VLB region L2 (e.g. color and/or brightness). Then this data is then captured and stored as New Data. Then the sequence would be: Initial Data on L1 and L2 (FIG. 5); New Data on L2 and Initial Data on L1 (FIG. 6); New Data on L1 and New Data on L2 (FIG. 7); Initial Data on L2 and New Data on L1 (FIG. 8); and Initial Data on L1 and Initial Data on L2 (FIG. 9). This sequence would then be interpreted as a person leaving the FOV. Note that FIGS. 5-9 may be the view from the one Camera in FIG. 1 and the two rectangles indicated may be the VLB regions L1 and L2 in FIG. 4, the VLB regions R1 and R2 not shown in FIGS. 5-9, but located toward the right side of the these figures may be at the same height as L1 and L2 and the FOV defined as the region between the left and the right VLB pairs (between L2 and R2). Alternatively, FIGS. 5-9 could be the view from the camera pointing toward the left side of the scene in FIG. 2.

Variation of the Algorithm in the Case of High Traffic Flow

Example of a High Traffic Algorithm:

If there is high traffic flow, then people may be moving back and forth across the cameras frequently, so that several people may cross back and forth across a camera without the VLB regions ever reverting back to the Initial Data. For example, when person #1 is closer to the camera and enters the FOV while person #2 leaves the FOV at the same time, the sequence of Data captured would be: Initially: New Data 1 on L1 and New Data 2 on L2; then: New Data 1 on both L1 and L2; then: New Data 1 on L2 and New Data 2 on L1. This would indicate one person entering the FOV and one person leaving the FOV. Here, color, as well as brightness, may be included in the Initial Data and the New Data to help distinguish New Data 1 from New Data 2.

Additional similar sequences to detect may be envisioned, e.g., two people entering or leaving the FOV right after each other, or more than 2 people entering/leaving the FOV at the same time or very close together. Thus, the same data appearing for a short time only on one sensor followed by the other sensor may be used to determine the entering/exiting event.

Also, for high traffic, more than two VLB regions may be employed on each side. For example, assume there are two pairs of VLB regions on the left side, LA1 and LA2 as the first pair and LB1 and LB2 as the second pair. If New Data 1 is detected on LA1 followed by the New Data on LA2, then one would be added to the number of people in the FOV as in operation the above case.

If the same New Data 1 is then detected on LB1 followed by the New Data on LB2 then, we would not add 1 to the FOV because it would be determined that the same person detected on sensor pair LB had already been detected on sensor pair LA. In this manner, multiple VLB regions could be employed on both sides and use this algorithm in high traffic flow situations. For example, if two people enter the FOV at the same time, and there was only one pair of VLB regions on each side of the FOV, then a first person may block the second person so that the VLB region would not pick up the data of the second person. By having multiple VLB region pairs, there would be multiple opportunities to detect the second person. In addition to looking at the brightness and color within each VLB region, a size of the area that is affected as well as the profile of brightness and color as a function of position across a VLB region for a given frame of the image.

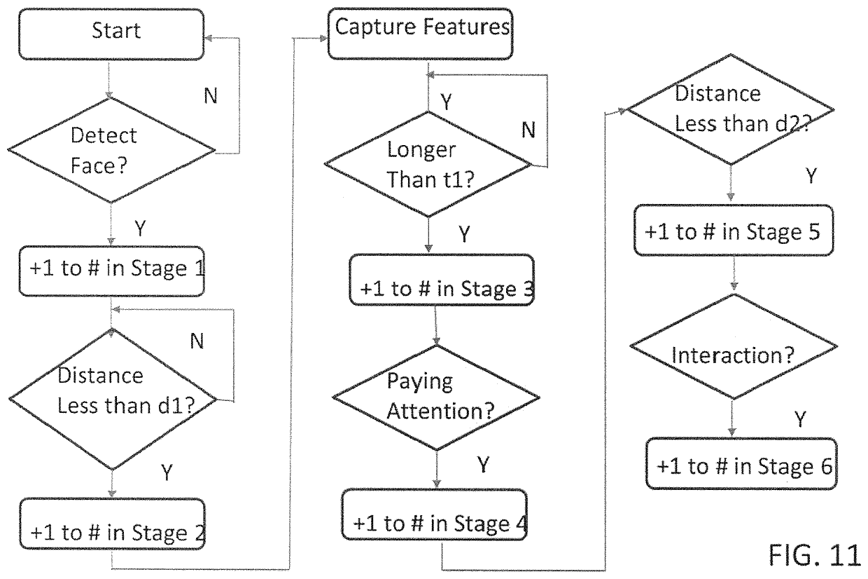

FIG. 11 illustrates a flow chart of how to monitor a number of people in various stages of the process from glancing to touch detection within the setting. This operation may run independently of that illustrated in FIG. 10 or in combination therewith. The processor may determine whether a particular person has entered into one or more of the following exemplary stages of interaction with the Digital Display.

Stage 1 means a face has been detected or a person glances at a screen.

Stage 2 means that a person has looked at the camera for at least a set number of seconds.

Stage 3 means that a person has looked at the screen with full attention for at least a set number of additional seconds.

Stage 4 means that a person is within a certain distance of the Digital Display.

Stage 5 means a person has interacted with the Digital Display with either a touch or a gesture.

Additional stages for people paying attention for additional time and/or coming closer and closer to the Digital Display, until they actually interact with the Digital Display, may also be analyzed.

If the method of FIG. 11 is being run independent of that of FIG. 10, then the following issues may arise. If a person looks away and, then, a few seconds later looks at the camera again, the camera may detect this person as two different people. There are multiple ways to solve this issue including:

1. Store data from the person when they first look at the camera. When a person first looks at the camera, capture and store the data, e.g., gender, age, eye size, ear size, distance between eyes and ears in proportion to the size of the head, and so forth. Then when the person looks away and then a new facial image is captured, the new facial image may be compared to the data stored to see if it matches the data. If so, then conclude that it is not a new person.

2. Alternatively, the people counting operation of FIG. 10 may be used to determine if a person is within the FOV, or how many people are within the FOV at a given time. For example, if one person is within the FOV and then a glance and then a Stage 1 or 2 image and then it disappears. Then if we receive a second glance, and from the method of the prior flow diagram of FIG. 10, no one has entered of exited the FOV, it may be assumed that this is the same person.

3. With either of the above two methods, when any of the operations in FIG. 11 that increase the number in a stage, this number may not be increased if it is determined that they are the same person that was previously captured. For example, if one person makes it to the box labeled “+1 to # in Stage 1” and then looks away and then we detect a new Face, but from the previous flow diagram of FIG. 10 we determine that this is the same person (i.e. no one has entered or exited the FOV), we could choose not to increment the number of people in Stage 1.

4. A combination of the approaches in number 1 and number 2 may be employed, e.g., a second glance may be considered a new glance only if at least one more person entering than exiting the FOV and the new data does not match any stored data stored within the a specific time interval.

First, whether a face is detected is determined, e.g., eyes or ears are looked for, e.g., using available anonymous video analytic programs available through, e.g., Cenique® Infotainment Group, Intel® Audience Impression Metrics (AIM), and others. If no, just keep checking for facial determination. If yes, then add one to the number of stage 1 (glances) occurrences.

In FIG. 11, once a face is detected, then determine if the face is within a predetermined distance d1, e.g., 12 feet. If not, the distance is rechecked. If so, a timer to track how long that person is looking at the screen, e.g., one or both eyes can be imaged, may be started. Then, try to capture analytics data: e.g. gender, age, emotion, attention, distance from camera, continuously as long as the person is looking at camera. Then determine whether the person is paying attention, e.g., reduced eye blinking. If not, return to tracking attention. If yes, then add one to the number of stage 2 (attention) occurrences. Then determine whether the person is still looking after a predetermined time period t1. If not, return to tracking time of attention. If yes, then add one to the number of stage 3 (opportunity) occurrences. Then, determine how far away the person is who has reached stage 3. Alternatively, the method could proceed here after stage 1 or stage 2 engagement is determined. If the person is further away than d2, e.g., 6 feet, keep determining distance. If less than d2 away, add one to Stage 4 (proximity). This means that the person has looked at screen, has paid attention and is within d2 feet of the screen. Several more steps may be included to determine how to bring people in closer and then proceed to interaction assessment.

Then, the method determines if there an interaction between the person and the display, e.g., a touch, gesture, and so forth. If not, the method keeps checking for an interaction. If yes, one is added to Stage 5 (interaction).

Based on the facial recognition, the processor may determine a total number of people viewing the Digital Display over a given time interval and may generate a report that includes the total number of people walking by the display as well as the total number of people that viewed the display within the given time interval.

Information displayed on the Digital Display (Digital Sign, Touch Screen, and so forth) in order to increase the numbers for each stage. For example, content may be changed based on data in the other stages. For example, content displayed may be changed based on the distance a person is away from the screen. For example, large font and small amount of data when people are further away. As a person gets closer, then the font may decrease, more detail and/or the image may otherwise be changed. Further, content may be changed when stages do not progress until progression increases. For example, the processor may track a number of people in each stage at any given time, where various media are used and a percentage of people that progress from one stage to another is tracked (conversion efficiency) according to the media used and specific media is chosen, and update which media is chosen according to the results to improve the conversion efficiency. Additionally, when the same content is being displayed in multiple settings, information on improving progress in one setting may be used to change the display in another setting.

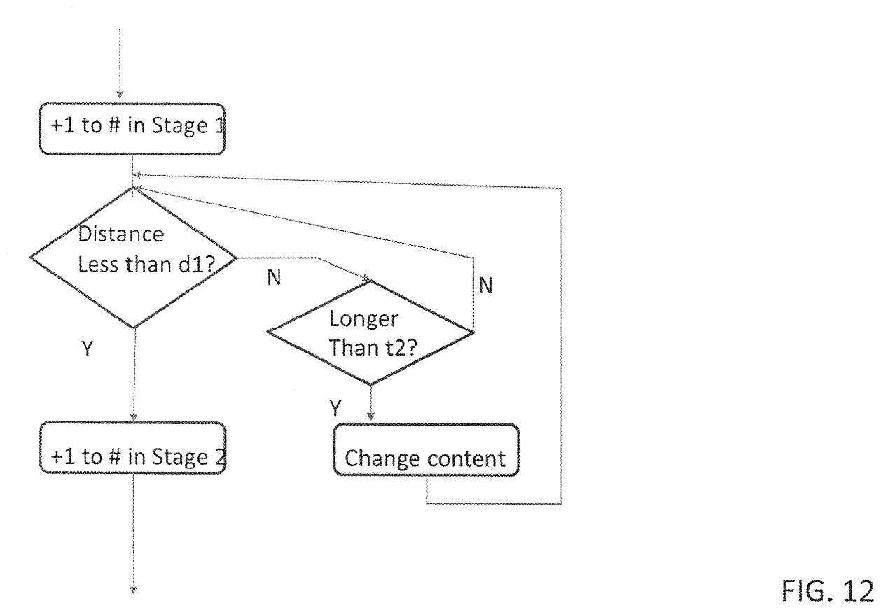

For example, as indicated in FIG. 12, after determining that the person is not as close as d1 and the image has been displayed for longer than a predetermined time T2, the content on the Digital Display may be changed, e.g., font size may be increased, less detail may be provided, and/or the image may be changed. This may be repeated until the person leaves the setting or moves closer to the Digital Display.

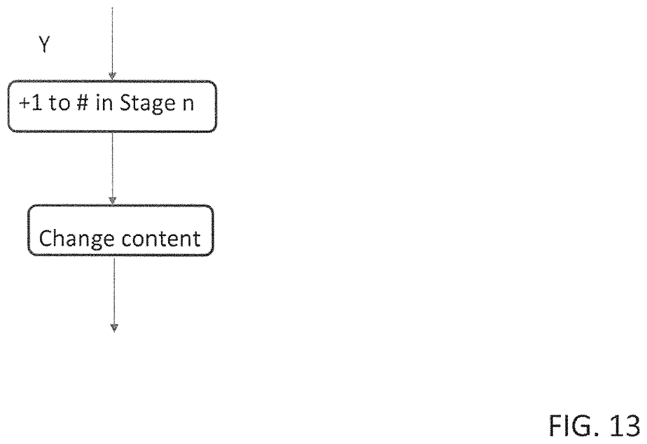

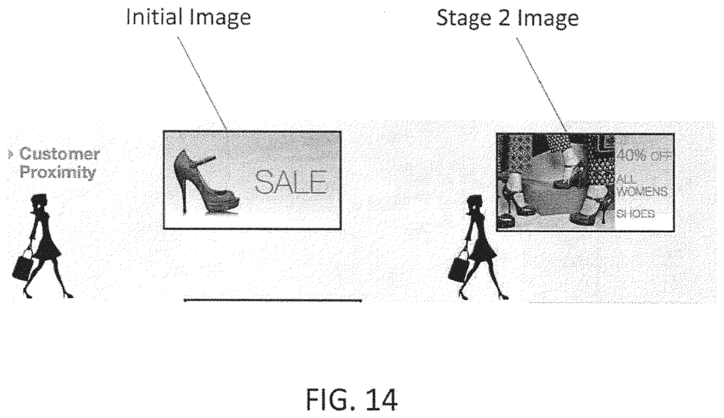

As noted above, a change in the image being displayed on the Digital Display may occur at any stage in FIG. 11. As shown in FIG. 13, when the next stage n is determined to have been reached, the content may be changed, e.g., font size may be decreased, more detail may be provided, and/or the image may be changed. For example, as shown in FIG. 14, when the person progresses to stage 2, the image may be changed from an initial image to a stage 2 image.

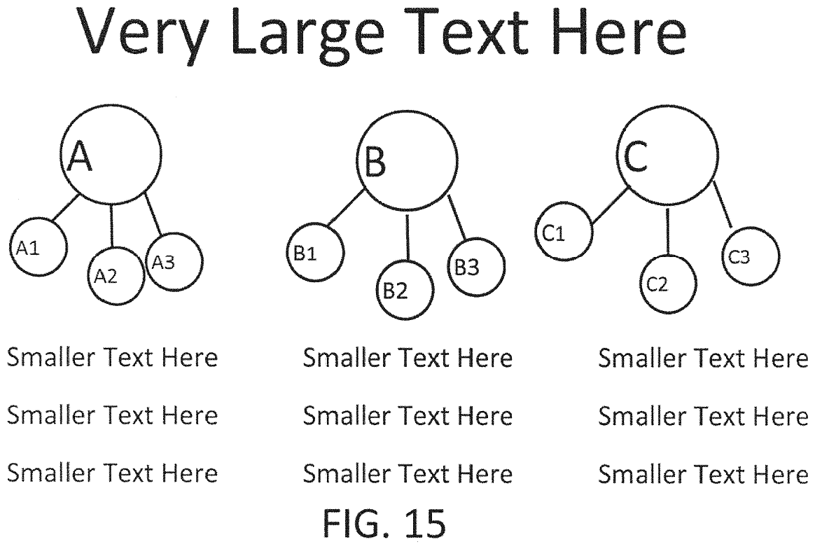

Alternatively and/or additionally to changing content of an image based on a person's proximity to the display, determined as described above, a resolution of the display may be altered, as shown in FIGS. 15 to 17. One or more regions of the display may remain at a full resolution to be visible over all viewing distances. For example, assume the display has a resolution of 1080p HD (1920×1080 pixels). Then depending on the size of the display and the viewing distance, the full resolution of the display may not be visible to a user. For example, if the display has a resolution of 1080p and a 65 inch diagonal, then consider three different viewing distance ranges:

range 1: 5-8 ft from the display

range 2: 10-16 ft from the display

range 3: 20 ft-30 ft from the display

For people in range 1, shown in FIG. 15, the full 1080p resolution would be viewable (approximately 1-1.5 times the diagonal of the display). The display shown in FIG. 15 includes very large text at the top, which is to be viewed over all viewing distance ranges, and various regions, e.g., buttons A-C and sub-buttons A1-C3, to be viewable by those in range 1.

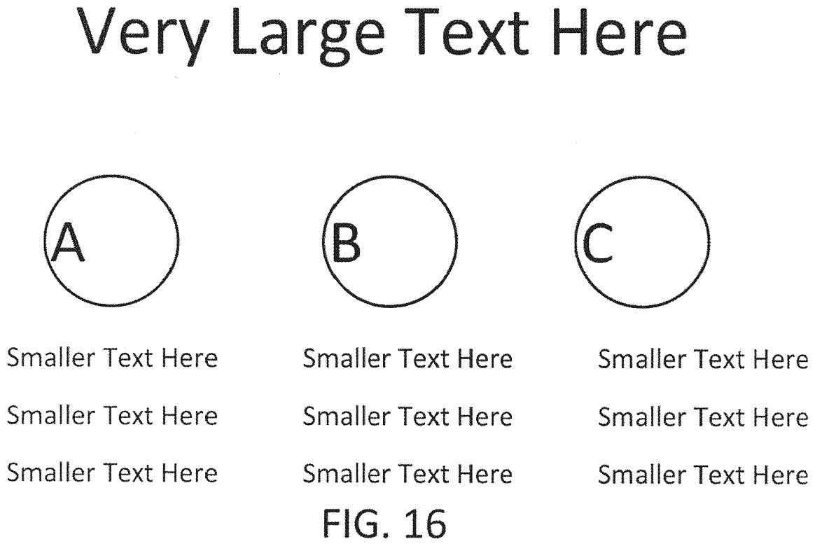

For people in range 2, shown in FIG. 16, the maximum viewable resolution will be about ¼ of the total resolution (approximately 960×540 pixels). The display shown in FIG. 16 includes very large text at the top, e.g. unchanged from that in FIG. 15, and various regions, e.g., buttons A-C, bigger than those in FIG. 15, to be viewable by those in range 2.

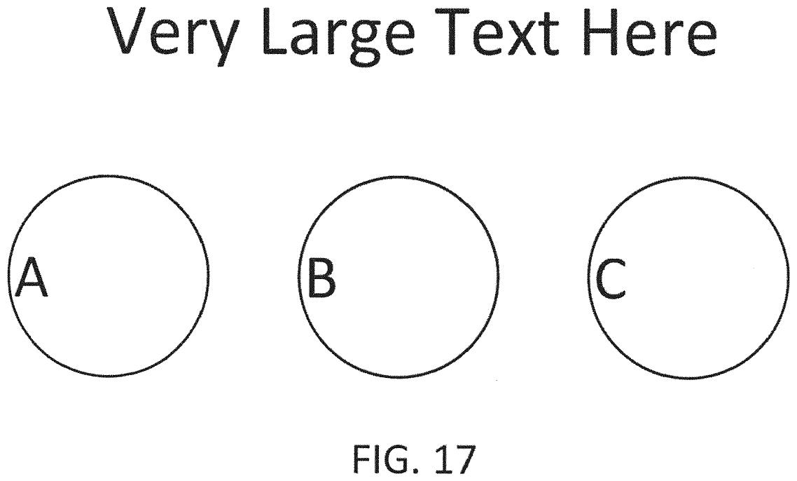

For people in range 3, shown in FIG. 17, the maximum viewable resolution would be approximately 480×270 pixels. The display shown in FIG. 17 includes very large text at the top, e.g. unchanged from that in FIG. 15, and various regions, e.g., buttons A-C which are larger than those shown in FIGS. 15 and 16, to be viewable by those in any of the ranges.

For a digital sign in a venue where people may be located anywhere within these ranges, i.e., from 5 feet away to 30 feet away, if the full 1080 p resolution of the display is used for example to display information and text, then a great deal of information can be displayed at once, but much of this information will be unreadable for people in range 2 and range 3. If the resolution were adjusted, for example by displaying only large text blocks, then the information would be viewable and readable by all, but much less resolution could be displayed at one time.

In accordance with an embodiment, the above problem is addressed by dynamically changing the resolution based on information supplied by the camera. If no people are detected for example within range 3, then the computer would display information on the display at very low resolution, e.g., divide the display into, in the above example 480×270 pixel blocks, so that each pixel block would be composed of 4×4 array of native pixels. This will effectively make text on the screen appear much larger (4× larger in each direction) and therefore viewable from further away. When a person is detected as moving into range 2, the display resolution may be increased, e.g., 960×540 pixels. Finally, when a person is detected as being as moving into range 1, the display may display the full resolution thereof. The closest person to the screen may control the resolution of the display. If nobody is detected, the display may go black, may turn off, may go to a screen saver, or may display the low resolution image.

The methods and processes described herein may be performed by code or instructions to be executed by a computer, processor, manager, or controller. Because the algorithms that form the basis of the methods (or operations of the computer, processor, or controller) are described in detail, the code or instructions for implementing the operations of the method embodiments may transform the computer, processor, or controller into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

By way of summation and review, one or embodiments is directed to counting people in a setting with elements integral with a mount for a digital display (or at least mounted on a same wall of the digital display), e.g., setting virtual laser beams regions in a camera(s) integrated in the mount for a digital display, simplifying set up, reducing cost, and allowing more detailed analysis, e.g., including using color to differentiate between people in a setting. In contrast, other manners of counting people in a setting, e.g., an overhead mounted camera, actual laser beams, and so forth have numerous drawbacks. For example, an overhead mounted camera will require separate placement and is typically bulky and expensive. Further, an overhead mounted camera will have a FOV primarily of a floor, resulting in view of tops of heads is not as conducive to differentiating between people and cannot perform face recognition. Using actual laser beams typically requires a door or fixed entrance to be monitored, having limited applicability, separate placement from the Digital Display, and cannot differentiate between people or perform face recognition.

Additionally, one or more embodiments is directed to increasing quality and quantity of interactions between people and a display, e.g., by dividing the interaction activity in to stages and capturing data on the number of people in each stage and then dynamically changing the content on the display with the purpose of increasing the percentage of conversions of each person in each stage to the subsequent stage.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system, comprising:
a digital display;
a camera structure;
a processor; and
a housing in which the display, the camera, and the processor are mounted as a single integrated structure, wherein the processor is to count a number of people passing the digital display and within the view of the display even when people are not looking at the display.

2. The system as claimed in claim 1, wherein:
the camera structure includes a single virtual beam; and
the processor is to detect disruption in the single virtual beam to determine presence of a person in the setting.

3. The system as claimed in claim 1, wherein:
the camera structure includes at least two virtual beams; and
the processor detects disruption in the at least two virtual beams to determine presence and direction of movement of a person in the setting.

4. The system as claimed in claim 1, wherein the camera structure includes at least two cameras mounted at different locations on the display.

5. The system as claimed in claim 4, wherein a first camera is in an upper center of the display and a second camera is a lateral camera on a side of the display, the processor to perform facial recognition from an output of the first camera and to determine the number of people from an output of the second camera.

6. The system as claimed in claim 5, further comprising a third camera on a side of the display opposite the second camera, the processor to determine the number of people from outputs of the second and third cameras.

7. The system as claimed in claim 1, wherein, when the processor detects a person, the processor then determines whether the person is glancing at the display.

8. The system as claimed in claim 7, wherein, when the processor has determined that the person is glancing at the display, the processor determines whether the person is looking at the display for a predetermined period of time.

9. The system as claimed in claim 8, wherein, the predetermined period of time is that sufficient for the processor to perform facial recognition on the person.

10. The system as claimed in claim 9, wherein, when the processor determines the person is close enough to interact with the display and detect that the display is interacted with, the processor maps that person to the interaction and subsequent related interactions.

11. The system as claimed in claim 1, wherein the processor is to determine the number of people within the FOV of the display at any given time.

12. The system as claimed in claim 1, wherein the processor is to perform facial detection to determine a total number of people viewing the display at a given time interval, and then generate a report that includes the total number of people walking by the display as well as the total number of people that viewed the display within the given time interval.

13. A system, comprising:
a digital display;
a camera structure;
a processor; and
a housing in which the display, the camera, and the processor are mounted as a single integrated structure, wherein processor is to process an image form the camera structure to detect faces to determine the number of people within the field of view (FOV) of the display at any given time, is to process regions of the camera structure to determine the number of people entering and exiting the FOV at any given time, even when a person is not looking at the camera, and is to determine a total number of people looking at the display during any particular time interval.

14. The system as claimed in claim 13, wherein the processor is to change content displayed on the digital display in accordance with a distance of a person from the digital display.

15. The system as claimed in claim 13, wherein the processor is to categorize different levels of a person's interaction with the digital display into stages including at least the of the following stages:
walking within range of a display;
glancing in the direction of a display;
walking within a certain distance of the display;
looking at the display for a certain period of time; and
touching or interacting with the display with a gesture.

16. The system as claimed in claim 15, wherein the processor is to change the content on the display in response to a person entering each of the at least three stages.

17. The system as claimed in claim 15, wherein the processor is to track a number of people in each stage at any given time,
track a percentage of people that progress from one stage to another, and
update an image being displayed accordingly.

18. A system, comprising:
a display in a setting, the display being mounted vertically on a wall in the setting;
a camera structure mounted on the wall on which the display is mounted; and
a processor to dynamically change a resolution on the display based on information supplied by the camera.

19. The system as claimed in claim 18, wherein the processor is to divide distances from the display into at least two ranges and to change the resolution in accordance with a person's location in a range.

20. The system as claimed in claim 19, wherein the range is determined in accordance with a person in range closest to the display.

21. The system as claimed in claim 19, wherein, when a person is in a first range closest to the display, the processor is to control the display to display a high resolution image.

22. The system as claimed in claim 21, wherein, when people are only in a second range furthest from the display, the processor is to control the display to display a low resolution image.

23. The system as claimed in claim 22, wherein, when people are in a third range between the first and second ranges, and no one is in the first range, the processor is to control the display to display a medium resolution image.

24. The system as claimed in claim 19, wherein, when no one is within any range, the processor is to control the display to display a low resolution image or no image.
